(19) United States
(12) Patent Application Publication
(10) Pub. No.: US 2004/0212110 A1
(43) Pub. Date: Oct. 28, 2004

(54) Press-molding apparatus and method of producing an optical element

(75) Inventors: Tadayuki Fujimoto, Tokyo (JP); Shinji Hada, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 10/833,321

(22) Filed: Apr. 28, 2004

(30) Foreign Application Priority Data
Apr. 28, 2003 (JP) 123906/2003

(51) Int. Cl. B29D 11/00; H05B 6/02; H05B 6/10

(52) U.S. Cl. 264/1.32; 425/808; 425/407; 264/403

(57) ABSTRACT

In a press-molding apparatus having upper and lower forming dies (413a, 413b) arranged opposite to each other and upper-die and lower-die heating arrangements for induction-heating the upper and the lower forming dies, the upper-die heating arrangement includes an upper-die induction heating coil (410a), an upper-die power supply (416a), and an upper die temperature controller (417a). The lower-die heating arrangement includes a lower-die induction heating coil (410b), a lower-die power supply 416b, and a lower-die temperature controller (417b). The power supplies are different in oscillation frequency. The upper and the lower forming dies are independently temperature-controlled and heated.

This application claims priority to prior Japanese application JP 2003-123906, the disclosure of which is incorporated herein by reference.

### BACKGROUND OF THE INVENTION

This invention relates to a press-molding apparatus which is used in a production process of an optical element or the like to obtain the optical element or the like by heating and softening a molding material (such as a preform preliminarily formed into an approximate shape) and then press-molding the molding material by the use of a forming die. This invention also relates to a method of producing the optical element.

In order to produce an optical element, a molding material, such as a glass material, in a heated and softened state is press-molded in a forming die which is given a predetermined shape by precision machining and which is heated to a predetermined temperature. As a consequence, a molding surface of the forming die is transferred onto the glass material. Thus, it is possible to obtain the optical element high in surface accuracy and profile accuracy even without post-treatment such as grinding and polishing. In this case, in order to part or release the optical element from the forming die after the press-molding, it is necessary to cool the forming die to an appropriate temperature before parting or releasing. Therefore, in order to mass-produce the optical element by continuously and repeatedly carrying out the press-molding, the forming die must be heated and cooled in a heating cycle within a predetermined temperature range at least between a pressing temperature and a parting temperature.

In this case, if induction heating is used, a coil itself as heating means does not generate heat but an object to be heated (heat generator) is directly heated. Therefore, rapid heating and rapid cooling can be carried out. Thus, the induction heating is advantageous in reduction of a molding cycle time.

In view of the above, it is known that, in precision pressing of the glass optical element, high-frequency induction heating assuring rapid heating and sufficient heating capacity is used as means for heating the forming die.

On the other hand, in order to improve the surface accuracy and the profile accuracy of the optical element to be molded, it is very important to accurately control a molding cycle according to a predetermined heating/cooling schedule in the state where upper and lower dies (upper and lower forming dies) are kept at the same temperature or given a predetermined temperature difference. Further, in case where a plurality of optical elements are simultaneously molded, it is important that the optical elements are uniform and high in accuracy.

As an example using high-frequency induction heating, Japanese Patent Application Publication (JP-A) No. H05-270847 (Reference 1) discloses a molding apparatus in which upper and lower dies are heated by a single induction heating coil. In this apparatus, in order to keep the upper and the lower dies at the same preselected temperature, the induction heating coil is moved up and down or the ratio of electric currents flowing through upper and lower parts of the coil is changed by the use of a saturable reactor.

Japanese Patent Application Publication (JP-A) No. H06-64932 (Reference 2) discloses another molding apparatus in which upper and lower dies are kept at predetermined temperatures by controllably increasing or decreasing electric currents supplied to coils surrounding the upper and the lower dies by changing the frequency of a single high-frequency transmitter.

However, in the molding apparatus described in Reference 1, the upper and the lower forming dies are heated by the single coil. Therefore, it is impossible to independently control the upper and the lower forming dies to desired temperatures. Further, it is troublesome to provide additional driving means for moving the induction heating coil up and down. Since the upper and the lower forming dies are arranged inside the single induction heating coil, heating efficiency is high in a coil center portion as compared with a coil end portion. As a result, confronting surfaces of the upper and the lower forming dies are relatively high in temperature as compared with remaining portions. The above-mentioned tendency is also observed in case where the saturable reactor is used. Therefore, in the apparatus disclosed in Reference 1, the upper and the lower forming dies are thermally deformed (warped).

Therefore, in case where the apparatus disclosed in Reference 1 is used and, in order to increase the productivity, a plurality of forming dies are arranged on upper and lower mother dies to simultaneously mold a plurality of optical elements, the mother dies are thermally deformed and warped as illustrated in FIG. 1. This impairs vertical coaxiality between upper and the lower dies. In this event, the optical element (for example, a lens) molded by the apparatus suffers occurrence of tilt, which causes the deterioration in eccentricity accuracy. In addition, the thickness is nonuniform among the optical elements molded by the individual forming dies.

On the other hand, in the apparatus disclosed in Reference 2, heating is carried out at a frequency shifted from a resonance frequency. Therefore, heating efficiency is not good and the productivity is decreased.

### SUMMARY OF THE INVENTION

The present inventor extensively studied in order to solve the above-mentioned problems. As a result, it is noted that, if a mother die has an elongated shape and a plurality of forming dies are linearly arranged on the mother die, high heat efficiency is obtained by induction heating with a compact design but those forming dies arranged at longitudinal opposite ends are greatly affected by the above-mentioned warp. From the above, it is important, in an apparatus for simultaneously pressing a plurality of objects, to prevent the mother die supporting the forming dies from being warped.

It is therefore an object of this invention to provide a press-molding apparatus and a method of producing an optical element, which are capable of independently and freely controlling temperatures of upper and lower mother dies (upper and lower dies) to desired temperatures so as to achieve high surface accuracy of an optical element as a molded product in a short production cycle time and to prevent the mother dies from being warped, thereby stably producing the optical element high in eccentricity accuracy and thickness accuracy.

It is another object of this invention to provide a press-molding apparatus and a method of producing an optical element, which are capable of forming a high-accuracy optical functional surface of the optical element by press-molding. In other words, desired optical performance can be obtained without requiring post-treatment, such as polishing, after the press-molding.

It is still another object of this invention to stably produce an optical element, in particular, an optical element with an aspheric surface, having a high eccentricity accuracy with a molding tilt of 2 arcmin or less and a molding decenter (decentration) of 10 μm or less.

It is yet another object of this invention to provide a press-molding apparatus and a method of producing an optical element, which are capable of simultaneously molding a plurality of optical elements with high production efficiency.

In order to achieve the above-mentioned objects, according to this invention, there is provided a press-molding apparatus comprising upper and lower dies facing with each other and upper-die and lower-die heating means for induction-heating the upper and the lower dies, respectively, wherein:

the upper-die and the lower-die heating means comprise induction heating coils as upper-die and lower-die heating coils surrounding the upper and the lower dies, respectively, and power supplies connected to the upper-die and the lower-die heating coils, respectively, the upper-die and the lower-die heating means having oscillation frequencies different from each other.

With the above-mentioned structure, the upper and the lower dies can independently be controlled in temperature so as to apply an optimum heating/cooling schedule in which an optical element high in surface accuracy and profile accuracy is molded in a short production cycle time.

In the press-molding apparatus according to this invention, the upper and the lower dies may comprise upper and lower mother dies each of which supports a plurality of forming dies, respectively.

When the above-mentioned heating means is used in this structure, it is possible, in the apparatus which has a plurality of forming dies and which is for simultaneously molding a plurality of molded products, to prevent the mother dies from being warped. It is consequently possible to keep the concentricity of each forming die so that the molded products are not deteriorated in eccentricity accuracy and are rendered uniform in thickness.

Preferably, the press molding apparatus according to this invention further comprises a positioning member formed on at least one of confronting surfaces of the upper and the lower dies to position the upper and the lower dies relative to each other when the upper and the lower dies approach each other.

With the above-mentioned structure, the upper and the lower mother dies can be positioned with high accuracy so that the eccentricity accuracy (decenter and tilt) is maintained within a predetermined range.

In the press-molding apparatus according to this invention, it is preferable that the upper-die heating coil and the lower-die heating coil are separated by a space corresponding to 0. 7 to 2 times the pitch of each heating coil. More specifically, a lower end of the upper-die heating coil and an upper end of the lower-die heating coil are spaced by a distance corresponding to 0.7 to 2 times the pitch of each heating coil. Preferably, the pitches of the upper-die and the lower-die heating coils are equal to each other and are substantially uniform. If not uniform, the space or the distance preferably corresponds to 0.7 to 2 times the average pitch of the heating coils.

If the space between the upper-die and the lower-die heating coils is smaller than 0.7 times the coil pitch, the temperatures of the confronting surfaces of the upper and the lower dies are excessively elevated between the upper-die and the lower-die heating coils so that the upper and the lower dies tend to be warped. On the other hand, if the space is greater than 2 times, the confronting surfaces of the upper and the lower mother dies, in particular, the positioning member, if it is provided, will hardly be heated and will easily be deprived of heat when the upper and the lower mother dies are heated inside the upper-die and the lower-die heating coils. This may result in an increase of a heating time to prolong the cycle time and in defective extension of the molding material.

According to this invention, there is provided a method of producing an optical element by press-molding a molding material by the use of upper and lower dies facing with each other, the method comprising the step of heating the upper and the lower dies to predetermined temperatures by induction-heating the upper and the lower dies with different oscillation frequencies by the use of upper-die and lower-die heating means each of which has a heating coil and a power supply.

With the above-mentioned method, it is possible to simultaneously produce a plurality of optical elements high in surface accuracy and profile accuracy in a yet shorter cycle time.

According to this invention, there is provided a method of producing an optical element, the method comprising a die heating step of heating upper and lower dies in the state where the upper and the lower dies are approached to be close or in contact with each other, a material supplying step of supplying a molding material between the upper and the lower dies after the upper and the lower dies are opened or separated from each other, and a molding step of pressing the upper and the lower dies to press-mold the molding material, at least the die heating step among the above-mentioned steps including the step of induction-heating the upper and the lower dies with different oscillation frequencies by the use of upper-die and lower-die heating means each of which has a heating coil and a power supply and which are independent from each other.

It is advantageous to carry out temperature control for die heating at least in the die heating step prior to the material supplying step.

In the method of producing an optical element, it is preferable that the oscillation frequency of one of the upper-die and the lower-die heating means is equal to 1.5 to 7 times that of the other.

In this event, even if the induction heating coils of the upper-die and the lower-die heating means are actuated by independent power supplies, it is possible to suppress an interference of oscillation and to stably heat the upper and the lower dies.

### BRIEF DESCRIPTION OF THE DRAWING

FIG. 1 is a view showing thermal deformation (warp) of mother dies;

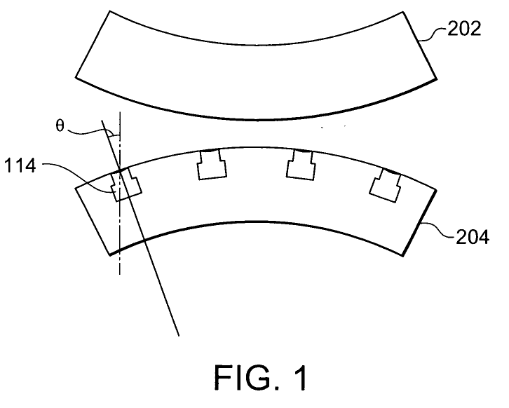

FIG. 2 is a schematic plan view of a press-molding apparatus according to one embodiment of this invention;

FIG. 3 is a schematic plan view of a pressing unit illustrated in FIG. 2;

FIG. 4 shows a side sectional view of the pressing unit illustrated in FIG. 3 together with a power supply circuit;

FIG. 5 is a schematic plan view of a floating plate and a support arm; and

FIG. 6 is a view for describing the relationship of an aspheric surface eccentricity, a molding tilt, and a molding decenter.

### DESCRIPTION OF THE PREFERRED EMBODIMENT

Now, an embodiment of this invention will be described with reference to the drawing.

In the following embodiment, this invention is applied to an apparatus for producing a glass optical element. However, a press-molding apparatus according to this invention is not limited to the embodiment but may be used for production of a resin optical element or production of various other products except the glass optical element and the resin optical element.

[Apparatus for Producing a Glass Optical Element]

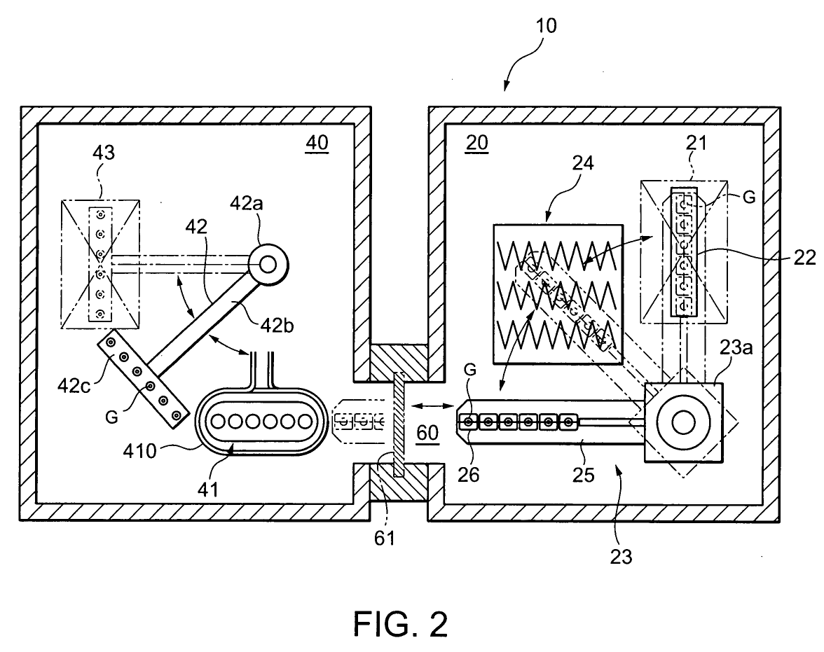

Referring to FIG. 2, an apparatus for producing a glass optical element will be described as an embodiment of the press-molding apparatus according to this invention.

The apparatus illustrated in FIG. 2 is for producing a small-sized collimator lens by pressing a glass preform having a spherical shape. Generally, a plurality of (six in the illustrated example) glass preforms G having a spherical shape are simultaneously supplied into a housing of the apparatus, heated and softened, pressed by forming dies, cooled, and delivered out of the housing. By repeating the above-mentioned operations, a number of collimator lenses are continuously produced.

As illustrated in FIG. 2, the apparatus 10 has a heating chamber 20 and a molding chamber 40. The heating chamber 20 and the molding chamber 40 are connected through a passage 60 having an open/close valve 61 to communicate with each other. A combination of the heating chamber 20, the molding chamber 40, and the passage 60 forms a closed space isolated from the outside. The closed space is surrounded by an outer wall which may be formed by a stainless steel or any other suitable material. By the use of a sealing material at connecting portions, airtightness of the closed space is assured. Upon molding the glass optical element, the closed space formed by the heating chamber 20, the molding chamber 20, and the passage 60 is filled with an inactive gas atmosphere. Specifically, by the use of a gas exchange apparatus (not shown), air within the closed space is evacuated and an inactive gas is filled instead. As the inactive gas, use is preferably made of a nitrogen gas or a mixed gas of nitrogen and hydrogen (for example, N₂+0.02 vol % H₂).

The heating chamber 20 is an area where the glass preforms supplied thereto are preliminarily heated prior to pressing. The heating chamber 20 is equipped with a preform supplying unit 22, a preform transporting unit 23, and a preform heating unit 24. Further, a supply preparing chamber 21 for supplying the glass preforms from the outside into the heating chamber 20 is provided.

The supply preparing chamber 21 is provided with six saucers (not shown) on which the six glass preforms are placed by the use of a robot arm (not shown), respectively. The glass preforms on the saucers are sucked by suction pads of the preform supplying unit 22 disposed in the supply preparing chamber 21 and are introduced into the heating chamber 20. In order to inhibit air flow into the heating chamber 20, the supply preparing chamber 21 is closed and filled with an inactive gas atmosphere after the glass preforms are placed on the saucers.

The preform transporting unit 23 receives the glass preforms introduced from the supply preparing chamber 21, transports the glass preforms to a heating area heated by the preform heating unit 24, and further transports the glass preforms in a heated and softened state to the molding chamber 40. The preform transporting unit 23 comprises an arm 25 and six plates 26 fixed to an end of the arm 25, and holds the glass preforms on the plates 26, respectively.

In this embodiment, the arm 25 with the plates 26 is horizontally supported by a driving portion 23a fixed in the heating chamber 20. Driven by the driving portion 23a, the arm 25 is rotated on a horizontal plane at a rotation angle of about 90° The arm 25 is extendable and retractable in a radial direction from the driving portion 23a as a center. With this structure, the arm 25 transports the glass preforms held on the plates 26 to the molding chamber 40.

The preform transporting unit 23 has an arm opening/closing mechanism (not shown) disposed in the driving portion 23a. The arm opening/closing mechanism serves to open the end of the arm 25 to drop the glass preforms on the plates 26 onto the forming dies.

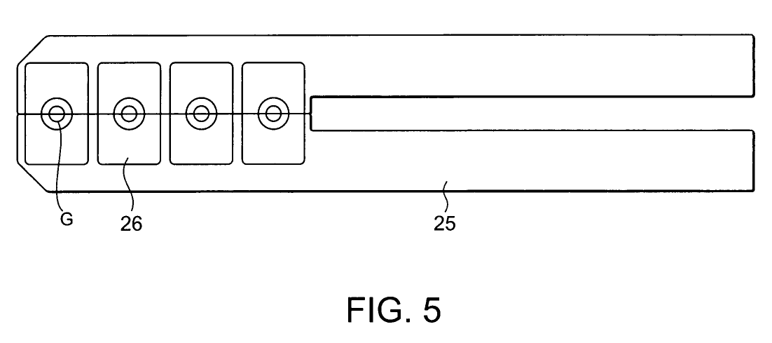

When the glass preform is preheated and transported in a softened state, the glass preform may be contacted with a transporting member, i.e., the preform transporting unit 23. In this event, a defect is caused on a glass surface, resulting in degradation of the profile accuracy of the optical element after molding. In view of the above, the preform transporting unit 23 is preferably provided with a floating member for making the glass preforms be transported in a floated state by the use of a gas. For example, use may be made of a combination of split-type floating plates and a separable arm supporting the floating plates as illustrated in FIG. 5.

In order to automatically remove the optical elements between mother dies separated from each other after molding the optical elements, it is preferable to provide a suction transporting unit having suction pads.

The preform heating unit 24 serves to heat the glass preforms supplied thereto to a predetermined temperature corresponding to a predetermined viscosity. In order to stably heat the glass preforms to the predetermined temperature, it is preferable to use a heater utilizing resistance heating by a resistor element (for example, a Fe-Cr heater). The preform heating unit 24 has a generally 90°-rotated U shape as seen from a lateral side and has upper and lower heater members disposed on upper and lower inner surfaces thereof. As illustrated in FIG. 2, the preform heating unit 24 is placed on a moving track of the glass preforms held on the arm 25.

The arm 25 is placed within the preform heating unit 24 except when the glass preforms are received from the preform supplying unit 22 and when the glass preforms are transported to the molding chamber 40. A heater surface temperature of the preform heating unit 24 may be about 1100° C. and a furnace atmosphere, i.e., an atmosphere between the upper and the lower heater members may be about 700-800° C. In this embodiment, a temperature difference is given between the upper and the lower heater members so as to prevent the arm 25 from being warped in the vertical direction.

On the other hand, the molding chamber 40 is an area where the glass preforms preliminarily heated in the heating chamber 20 are pressed and molded to produce the glass optical elements having a desired shape. The molding chamber 40 is equipped with a pressing unit 41 and a delivering unit 42 for delivering the glass optical elements. Further, a removal preparing chamber 43 is provided in order to deliver the glass optical elements to the outside after the glass optical elements are press-molded..

The pressing unit 41 receives the six glass preforms transported by the preform transporting unit 23 from the heating chamber 20 and presses the glass preforms to obtain the glass optical elements having a desired shape. The pressing unit 41 has upper and lower dies provided with molding surfaces and simultaneously presses the six glass preforms supplied therebetween by the molding surfaces. The six glass preforms on the arm 25 of the preform transporting unit 23 are dropped onto the lower die by opening the end of the arm 25. Immediately after the arm 25 is retreated from a position between the upper and the lower dies, the lower die moves up towards the upper die. Consequently, the glass preforms clamped between the upper and the lower dies are pressed. Each of the upper and the lower dies comprises the mother die and the forming dies supported on the mother die.

The forming dies are surrounded by a high-frequency induction heating coil 410 for heating the forming dies. Prior to pressing the glass preforms, the forming dies are heated by the induction heating coil 410 and kept at a predetermined temperature. The temperature of the forming dies upon pressing may be substantially equal to or slightly lower than the temperature of the glass preforms preliminarily heated. As will later be described in detail, heating by the induction heating coil 410 is carried out independently for the upper and the lower dies.

The delivering unit 42 serves to deliver the glass optical elements pressed by the pressing unit 41 to the removal preparing chamber 43. The delivering unit 42 has a driving portion 42a, an arm 42b rotatably supported on the driving portion 42a, and six suction pads 42c fixed to an end of the arm 42b. The suction pads 42c sucks the six glass optical elements on the forming dies of the lower die by vacuum sucking so as to enable delivery of the glass optical elements by the delivering unit 42. The glass optical elements thus sucked are delivered by the rotation of the arm 42b to a position below the removal preparing chamber 43 and are placed on an elevating member (not shown) equipped at that position. After the arm 42b is retreated, the elevating member is moved upward and the glass optical elements are delivered to the removal preparing chamber 43.

In this embodiment, a lens mounting surface of the elevating member closes an opening of the removal preparing chamber 43, which communicates with the molding chamber 40, to thereby inhibit gas exchange between the removal preparing chamber 43 and the molding chamber 40. After opening an upper part of the removal preparing chamber 43, the glass optical elements in the removal preparing chamber 43 are successively delivered to the outside by the use of a delivering member such as a robot arm. After the glass optical elements are delivered, the removal preparing chamber 43 is closed and filled with an inactive gas.

[Pressing Unit]

Next, the pressing unit 41 will be described in detail.

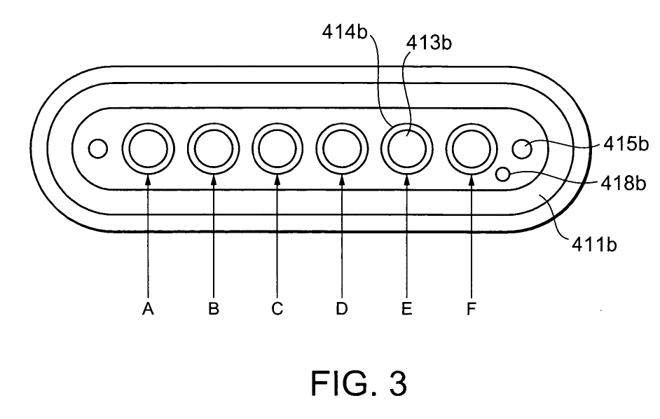

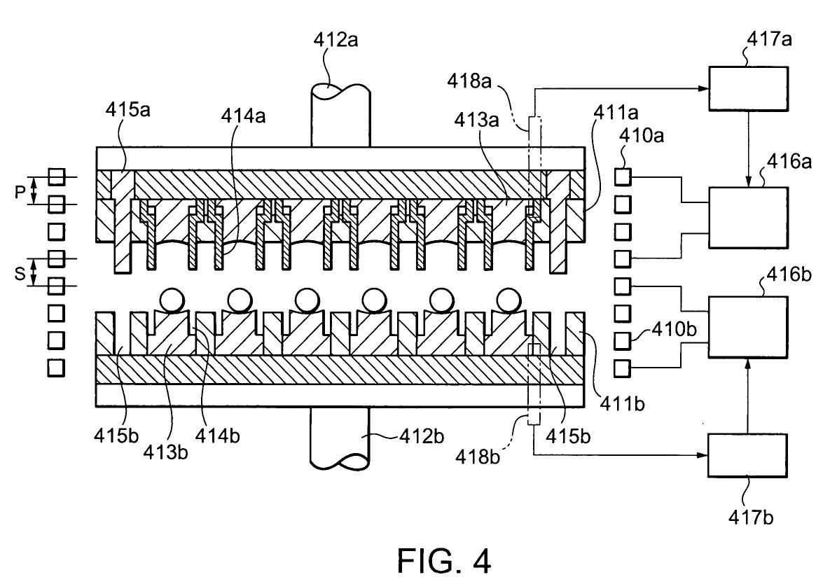

Referring to FIGS. 3 and 4, the pressing unit 41 comprises a pair of upper and lower mother dies 411a and 411b having an elongated shape and attached to upper and lower main shafts 412a and 412b as fixed and movable main shafts, respectively. The upper mother die 411a and the lower mother die 411b are provided with six upper forming dies 413a and six lower forming dies 413b, respectively. The upper and the lower mother dies 411a and 411b are surrounded by upper-die and lower-die induction heating coils 410a and 410b, respectively.

The upper mother die 411a is attached to the upper main shaft 412a, which is fixed to an apparatus body. The lower mother die 411b is attached to the lower main shaft 412b driven by a servo motor (not shown). With the above-mentioned structure, the lower mother die 411b can be moved to an appropriate position and then stopped in various steps (a die heating step, a material supplying step, a pressing step, a parting step, and a removing step) of a molding process.

Herein, a combination of the upper mother die 411a and the upper forming dies 413a forms the upper die. Likewise, a combination of the lower mother die 411b and the lower forming dies 413b forms the lower die.

The upper and the lower mother dies 411a and 411b are contacted and separated in response to a driving signal sent from a molding controller (not shown) to the servo motor in synchronization with a predetermined molding cycle.

The distance S between the upper-die and the lower-die induction heating coils 410a and 410b in the vertical direction preferably corresponds to 0.7 to 2 times the average coil pitch P of the upper-die and the lower-die induction heating coils 410a and 410b, more preferably, 0.8 to 1.5 times. If the distance S between the upper-die and the lower-die induction heating coils 410a and 410b in the vertical direction is smaller than the above-mentioned range, the upper and the lower dies tend to warp due to temperature elevation at confronting surfaces of the upper and the lower dies. If the distance S is greater than the above-mentioned range, the upper and the lower dies are not closely adjacent to each other when the upper and the lower dies are heated at positions where they are surrounded by the upper-die and the lower-die induction heating coils. Accordingly, the heating efficiency at the confronting surfaces of the upper and the lower dies is decreased.

In this embodiment, in order to arrange the upper-die and the lower-die induction heating coils 410a and 410b in close proximity to each other, the distance between the coils is substantially equal to the average coil pitch.

As will later be described in detail, the upper-die and the lower-die induction heating coils 410a and 410b are independently connected to power supplies and temperature controllers, respectively, whose outputs are independently controllable. Therefore, even if the upper and the lower forming dies 413a and 413b are considerably different in heat capacity, it is possible to controllably heat the upper and the lower forming dies 413a and 413b to the same temperature and, on the contrary, to give a desired temperature difference between the upper and the lower forming dies 413a and 413b. The numbers of turns and the ranges of location of the upper-die and the lower-die induction heating coils 410a and 410b are determined taking into account the heat capacities of the upper and the lower forming dies 413a and 413b.

As the material of the upper and the lower mother dies 411a and 411b, use is made of a heat generating material which generates heat by induction heating and which has heat resistance. For example, the heat generating material may be a tungsten alloy or a nickel alloy. As the upper and the lower forming dies 413a and 413b, a ceramic material, such as silicon carbide or silicon nitride, or cemented carbide may be used.

The upper and the lower forming dies are subjected to precision machining in accordance with a desired shape of the optical element.

In case where at least one of the upper and the lower forming dies has an aspheric surface, the effect of this invention is remarkable. This is because the aspheric surface has a single axis and, therefore, effective prevention of the molding tilt greatly contributes to the optical performance.

It is noted here that the heat generating material for use as the upper and the lower mother dies 411a and 411b preferably has a coefficient of thermal expansion approximate to that of the material of the upper and the lower forming dies 413a and 413b. For example, in case where the forming dies are made of a ceramic material, a tungsten alloy is preferably used as the heat generating material.

On the molding surface of each of the upper and the lower forming dies 413a and 413b, a releasing film may be formed. As the releasing film, a film of precious metal (such as Pt, Ir, Au) or a film containing carbon as a main component may be used. The carbon film is advantageous because it is inexpensive and excellent in releasing effect.

The upper and the lower mother dies 411a and 411b are completely separated when the molding material is supplied and when the molded product is removed. Therefore, when the upper and the lower mother dies 411a and 411b are moved towards each other upon pressing, the upper and the lower mother dies 411a and 411b must be precisely positioned. To this end, guide pins 415a and guide holes 415b are provided in order to position the upper and the lower mother dies 411a and 411b with respect to each other. The guide pins 415a and the guide holes 415b may collectively be called a guide member. In this embodiment, the upper mother die 411a is provided with the guide pins 415a while the lower mother die 411b is provided with the guide holes 415b.

Further, each of the six upper forming dies 413a is provided with a sleeve 414a formed at an outer periphery thereof. On the other hand, each of the six lower forming dies 413b is provided with a sleeve hole 414b to be fitted to the sleeve 414a with a narrow clearance. The sleeves 414a and the sleeve holes 414b may collectively be called a sleeve member. With this structure, when the upper and the lower mother dies 411a and 411b approach each other, the sleeve 414a of the upper forming die 413a and the sleeve hole 414b of the lower forming die 413b slide along each other and are fitted to each other with the narrow clearance. Thus, the upper and the lower forming dies 413a and 413b are further precisely positioned with respect to each other. As a result, the eccentricity accuracy (decenter and tilt) can be maintained within a predetermined range.

Preferably, the clearance between the guide pin 415a and the guide hole 415b for positioning the upper and the lower mother dies 411a and 411b is 10-40 μm. On the other hand, the clearance between the sleeve 414a of the upper forming die 413a and the sleeve hole 414b of the lower forming die 413b is preferably 1-10 μm. In either case, if the clearance is smaller than the above-mentioned range, sliding can not smoothly be carried out. If the clearance is greater than the above-mentioned range, play is caused and the positioning accuracy is decreased.

Without being restricted to the above, the upper and the lower dies (the upper and the lower mother dies and the upper and the lower forming dies) may be positioned in a different manner. For example, a protruding member may be formed on the lower mother die (lower die). Also, only one of the guide member (the guide pins and the guide holes) and the sleeve member (the sleeves and the sleeve holes) may be formed.

As illustrated in FIG. 4, the induction heating coils 410a and 410b in this embodiment are respectively connected to independent power supplies (an upper-die power supply 416a and a lower-die power supply 416b). The upper-die and the lower-die power supplies 416a and 416b are respectively connected to independent temperature controllers (an upper-die temperature controller 417a and a lower-die temperature controller 417b). The upper-die power supply 416a independently supplies an electric current to the upper-die induction heating coil 410a while the lower-die power supply 416b independently supplies an electric current to the lower-die induction heating coil 410b.

In this embodiment, a combination of the upper-die induction heating coil 410a, the upper-die power supply 416a, and the upper-die temperature controller 417a forms an upper-die heating arrangement while a combination of the lower-die induction heating coil 410b, the lower-die power supply 416b, and the lower-die temperature controller 417b forms a lower-die heating arrangement.

The upper-die power supply 416a and the lower-die power supply 416b have different oscillation frequencies to be supplied to the induction heating coils 410a and 410b. Herein, the ratio of the oscillation frequencies of the upper-die and the lower-die power supplies 416a and 416b is preferably 1:1.5 or more, more preferably, 1:1.5 to 1:7.

If the oscillation frequencies of the upper-die and the lower-die heating arrangements are significantly different, heating environments, such as the penetration depths of induction heating and energy transfer efficiencies from the coils, are different so that press molding conditions are different between the upper and the lower dies. The ratio of the oscillation frequencies within the above-mentioned range is advantageous because the heating environments for the upper and the lower dies are substantially same. Further, within the above-mentioned range, the degrees of oxidation of the mother dies as a result of heating are substantially equivalent. Therefore, heat radiation conditions under the influence of surface conditions are substantially equivalent also. More preferably, the range is 1:1.5 to 1:3, especially, 1:1.5 to 1:2.

Either of the oscillation frequencies of the upper-die and the lower-die power supplies 416a and 416b may be higher. Preferably, the power supply for the coil corresponding to one of the upper and the lower dies which is smaller in heat capacity has a higher frequency.

Preferably, the oscillation frequency of each of the upper-die and the lower-die power supplies 416a and 416b falls within a range of 15-100 kHz. The reason is as follows. If the oscillation frequency of the power supply exceeds 100 kHz, the penetration depth of induction heating is small (shallow) so that only a surface portion of the mother die is heated to a high temperature. In this event, radiation heat loss towards the surroundings is increased and the heating efficiency of the forming dies arranged on the mother die is decreased. Such a high frequency is unfavorable in view of the cost also.

The oscillation frequency lower than 15 kHz falls within an audio frequency band and results in production of an unpleasant sound or a noise. For example, one and the other of the oscillation frequencies of the upper-die and the lower-die power supplies 416a and 416b are 15-50 kHz and 30-100 kHz, preferably, 15-30 kHz and 30-45 kHz. The difference between one and the other is preferably 10 kHz or more.

Preferably, each of the upper-die and the lower-die heating arrangements is provided with noise protection (such as a shield or a noise filter).

Temperature control for the upper and the lower forming dies 413a and 413b is carried out in the following manner. The mother dies 411a and 411b are provided with an upper-die temperature sensor (thermocouple) 418a and a lower-die temperature sensor (thermocouple) 418b, respectively. Outputs of the upper-die and the lower-die temperature sensors 418a and 418b are supplied to upper-die and lower-die temperature controllers 417a and 417b, respectively. In order that the predetermined temperatures are reached, for example, PID (Proportion, Integration, Derivation) control is carried out. Even if the upper and the lower mother molds 411a and 411b are considerably different in heat capacity, target temperatures can be reached by independently controlling the temperatures of the upper and the lower forming dies 413a and 413b in correspondence to the heat capacities of the mother dies and power supply capacities. Further, by adjusting the outputs of the upper-die and the lower-die power supplies 416a and 416b in conformity with the heat capacity ratio between the upper and the lower mother dies 411a and 411b, the upper and the lower forming dies 413a and 413b can reach the target temperatures in heating times substantially equal to each other.

[Method of Producing a Glass Optical Element]

Description will be made of a method of producing a glass optical element according to one embodiment of this invention by the use of the apparatus having the above-mentioned structure.

(a) Die Heating Step

The upper and the lower forming dies after completion of a previous molding cycle are cooled to a temperature around Tg or lower than Tg. Therefore, it is necessary to heat the upper and the lower forming dies to a temperature suitable for press molding. Specifically, the induction heating coils surrounding the upper and the lower mother dies are supplied with electric currents to make the upper and the lower mother dies generate heat. By heat conduction, the upper and the lower forming dies are heated to the predetermined temperatures. At this time, it is important to minimize variation in temperature among the forming dies.

The predetermined temperatures of the upper and the lower forming dies are generally equal to each other. Alternatively, depending upon the shape and the diameter of the lens to be molded, a temperature difference may be given between the upper and the lower forming dies.

The heat capacities of the upper and the lower mother dies are often different so that the heating efficiencies are different. Taking this into consideration also, the number of turns of the high-frequency induction heating coils and the output ranges are determined.

In the apparatus in this embodiment, the upper-die and the lower-die heating coils 410a and 410b are closely adjacent to each other in order to heat the upper and the lower mother dies in close proximity to each other. As described above, the distance between the upper-die and the lower-die heating coils 410a and 410b preferably corresponds to 0.7 to 2 times the coil pitch. If the upper-die and the lower-die heating coils 410a and 410b are apart from each other by a large distance as compared with the coil pitch, the protruding members such as the sleeves 414a protruding above the confronting surfaces of the upper and the lower mother dies 411a and 411b are hardly heated and are easily deprived of heat when the upper and the lower mother dies 411a and 411b are heated inside the upper-die and the lower-die heating coils 410a and 410b. This results in an increase in heating time to prolong the cycle time, in fitting error when the sleeves 414a are fitted to the sleeve holes 414b to restrict the position, and in defective extension of the molding material.

In this embodiment, the protruding members such as the sleeves 414a and the guide pins 415a formed on the upper mother die 411a may be contacted with or fitted to the sleeve holes 414b and the guide holes 415b of the lower mother die 411b during the die heating step. If the die heating is carried out while the protruding members such as the sleeves 414a and the guide pins 415a are contacted with or fitted to the sleeve holes 414b and the guide hole 415b, an exposed portion of the protruding members is reduced so that cooling by the atmosphere is suppressed and the exposed portion is sufficiently heated.

However, contacting or fitting is not essential but it is sufficient that the upper and the lower confronting surfaces and the protruding members form a space capable of preventing convection of an atmospheric gas.

The predetermined temperatures of the upper and the lower mother dies 411a and 411b may be equal to each other or may be given a temperature difference. For example, depending upon the shape and the diameter of the optical element to be molded, the temperature of the lower mother die 411b may be higher or lower than that of the upper mother die 411a. The temperatures of the upper and the lower mother dies 411a and 411b may correspond to 10⁸ to 10¹² poises as the viscosity of the glass preform. In case where the temperature difference is given between the upper and the lower mother dies 411a and 411b, the temperature difference preferably falls within a range of 2-15° C.

The temperature control of the upper and the lower mother dies 411a and 411b is carried out in the following manner. The outputs of the upper-die and the lower-die temperature sensors (thermocouples) 418a and 418b on the upper and the lower mother dies 411a and 411b are supplied to the upper-die and the lower-die temperature controllers 417a and 417b, respectively. In order that the predetermined temperatures are reached, for example, PID control is carried out.

Thus, the upper and the lower forming dies 413a and 413b are independently and quickly controlled in temperature.

(b) Material Supplying Step

Between the upper and the lower dies, the preforms (glass material) having been transported are supplied and placed on the lower dies. The glass material thus supplied may be a glass material preliminarily formed into a predetermined shape with an appropriate weight and softened to the viscosity suitable for molding. Alternatively, the glass material at a temperature lower than the temperature suitable for molding may be supplied between the upper and the lower dies and further heated on the dies.

In case where the glass material is preliminarily heated to a temperature higher than the predetermined temperature of the forming dies and is supplied in a softened state (in case of so-called non-isothermal press), the die temperature must precisely be controlled. Therefore, this invention is advantageously applied. In this event, the molding cycle time can be shortened so as to improve the production efficiency.

At that time, the temperature of the glass material corresponds to the viscosity lower than 10⁹ poises, preferably 10⁶-10⁸ poises.

When the glass material in a softened state is transported and placed on the lower die, the glass material may be contacted with a transporting member to cause a surface defect. This affects the surface profile of the optical element to be molded. In view of the above, it is preferable to use an arrangement for making the glass material being softened be transported in a floated state by the use of a gas and dropping the glass material onto the lower die.

(c) Pressing Step

In the state where the upper and the lower dies and the glass material fall within the respective predetermined temperature ranges and the glass material is heated and softened, the lower mother die is moved upward to press the glass material so that the molding surfaces of the upper and the lower dies are transferred. As a consequence, the glass optical element having a predetermined surface profile is molded. The lower die is moved upward by actuating driving means (for example, a servo motor). In case where the glass material in a heated and softened state is supplied, pressing is carried out immediately after supplying.

The up stroke of the lower die for pressing is preliminarily determined with reference to the thickness of the optical element to be molded, taking into account heat shrinkage of the glass in a subsequent cooling step. A pressing schedule may appropriately be determined depending upon the shape and the size of the optical element to be molded. Furthermore, a plurality of times of pressing may be carried out, for example, by carrying out a first pressing operation, then reducing or releasing the load, and thereafter carrying out a second pressing operation.

(d) Cooling/Parting Step

In the state where the pressure is maintained or decreased, the glass optical elements thus molded are kept in tight contact with the forming dies. After cooled down to a temperature corresponding to 10¹² poises as the viscosity of the glass, the glass optical elements are separated from the dies. The parting temperature is preferably not higher than a temperature corresponding to 10^{12.5} poises, more preferably within a temperature range corresponding to 10^{12.5} to 10^{13.5} poises in view of reduction of a production cycle time.

(e) Removing Step

By the use of a removing arm having a sucking member or the like, the glass optical elements having been molded are automatically removed from the upper and the lower dies separated from each other.

By repeating the above-mentioned steps, continuous press molding is carried out.

In the foregoing embodiment, the upper die is fixed while the lower die is movable. Alternatively, the upper die may be movable while the lower die may be fixed. Further alternatively, both of the upper and the lower dies may be movable.

For example, the optical element produced by the method of this invention may be a lens. Without being restricted in shape, the lens may be a bi-convex lens, a bi-meniscus lens, a convex meniscus lens, and so on. In particular, even in a medium-aperture lens having a lens outer diameter of 15-25 mm, the thickness accuracy and the eccentricity accuracy can be excellently maintained. For example, the thickness accuracy is within ±0.03 mm. As the eccentricity accuracy, this invention is advantageously applicable to production of the optical element having a tilt of 2 arcmin or less and a decenter of 10 μm or less.

Next, description will be made of the result of a specific example in which the glass optical element was produced by the use of the molding apparatus and the method of this invention, together with result of a comparative example.

### EXAMPLE 1

By the use of a press molding apparatus similar to that illustrated in FIGS. 2 through 4 but having four forming dies on each of the mother dies, a flat spherical preform of a barium borosilicate glass (having a transition point of 515° C. and a sagging point of 545° C.) was pressed to obtain a bi-convex lens (having one surface as a spherical surface and the other surface as an aspheric surface, the radius of curvature of the spherical surface being 50 mm, the paraxial radius of curvature of the aspheric surface being 28.65 mm, the center thickness being 2 mm) having an outer diameter of 18 mm.

The above-mentioned lens has a flange-like flat portion at its periphery. By comparing the maximum thickness and the minimum thickness at that portion, the tilt of the axis of each of the upper and the lower forming dies, i.e., the molding tilt can be measured.

Four sets of the forming dies precision-machined for the bi-convex lenses and the sleeve were attached to the upper and the lower mother dies. The upper and the lower mother dies had a volume ratio (=heat capacity ratio) of 10:7. The upper-die power supply of the apparatus had a maximum output of 25 kW and a frequency of 18 kHz while the lower-die power supply had a maximum output of 25 kW and a frequency of 33 kHz.

The upper and the lower mother dies were disposed in close proximity to each other so that the sleeves protruding from the upper mother die were almost brought into contact with the sleeve holes of the lower mother die. The upper-die and the lower-die heating coils were supplied with high-frequency currents from the upper-die and the lower-die high-frequency power supplies to simultaneously heat the upper and the lower mother dies. Heating was controllably carried out so that the upper and the lower mother dies reached the same temperature of 580° C. (corresponding to 10^{8.5} poises as the viscosity of the glass).

Then, by a preform heating furnace 24, the preforms of a flat spherical shape were heated to 625° C. (corresponding to 10⁷ poises as the viscosity of glass) and softened while they were floated on split-type floating plates (made of glassy carbon) on an openable/closable supporting arm illustrated in FIG. 5 by a gas stream blowing up from the below. Thereafter, the lower mother die was moved down and stopped at a supply position. The supporting arm was moved to a position above the lower mother die. Directly above the four lower forming dies, the supporting arm was quickly opened to drop and supply the preforms onto the respective lower forming dies. In order to inhibit the preforms from being displaced, the preforms were dropped by the help of guiding means (funnel-like member) interposed between the support arm and the lower forming die.

Immediately thereafter, the support arm was retreated and the lower mother die was moved upward. Then, pressing was started at a pressure of 150 kg/cm².

After starting the pressing, pressing was continued without heating until the upper and the lower mother dies are brought into contact with each other. Then, a nitrogen gas was blown to side surfaces of the mother dies. Simultaneously, the nitrogen gas was made to flow into the mother dies to start cooling. Thereafter, cooling was continued until the temperature not higher than the transition point was reached. Then, the lower mother die was moved down and the press molded products were removed by a removing unit having suction pads.

Subsequently, the lower mother die was moved up and a next pressing cycle was continuously carried out. In this apparatus, the heating rates of the upper and the lower mother dies were substantially equal to each other and the cycle time was 60 seconds. The performances of the four lenses thus molded are shown in Table 1.

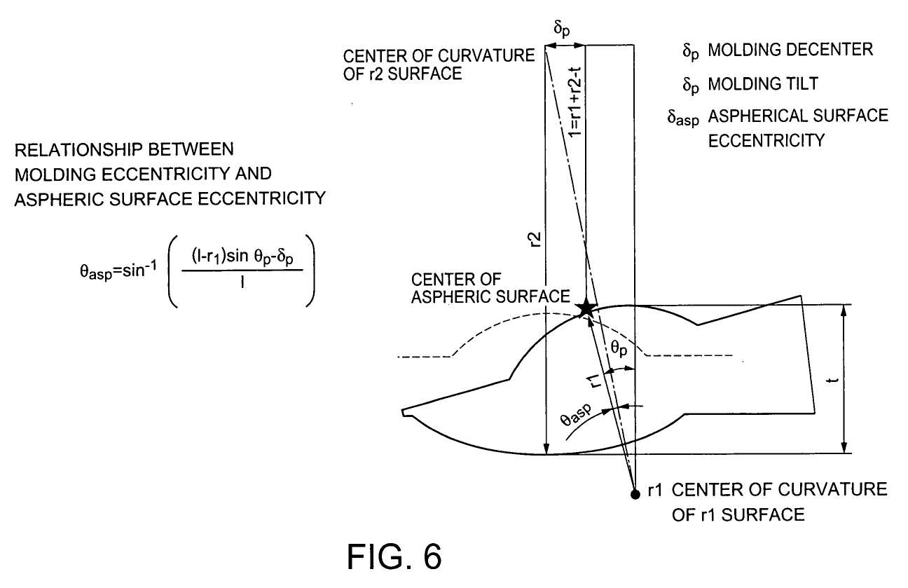

Herein, the molding tilt is an eccentricity of the lens resulting from the tilt of the axis of each of the upper and the lower forming dies. The molding decenter is an eccentricity of the lens resulting from the shifts of the upper and the lower forming dies in the horizontal direction. The eccentricity of the aspheric surface was measured by a known aspheric surface analyzer. The molding tilt was calculated from the difference between the minimum thickness and the maximum thickness of the flat portion at the periphery of the molded lens and the press diameter of the lens. The relationship between the aspheric surface eccentricity, the molding tilt, and the molding decenter is illustrated in FIG. 6. From the relationship, the molding decenter was calculated.

All the four lenses satisfied the specification including the surface accuracy.

TABLE 1

| | aspheric | | | |
|---|---|---|---|---|
| | surface | molding | molding | center |
| | eccentricity | tilt | decenter | thickness |
| specification | | <2′ 30″ | <0.015 mm | 2 ± 0.03 mm |
| position A | 1′ 10″ | 1′ 30″ | 0.005 mm | 2.005 mm |
| position B | 1′ 00″ | 1′ 00″ | 0.008 mm | 2.003 mm |
| position C | 1′ 00″ | 1′ 00″ | 0.009 mm | 1.993 mm |
| position D | 1′ 10″ | 1′ 00″ | 0.011 mm | 2.010 mm |

In case where a plurality of (four in this example) forming dies are arranged on each of the mother dies of an elongated shape and the four preforms are simultaneously pressed as described above, the mother dies are prevented from being warped because the upper-die and the lower-die heating arrangements are independent from each other. Therefore, the lenses pressed by the forming dies at opposite ends are not deteriorated in optical performance and stable production is possible. Since thermal deformation of the mother dies is suppressed, neither fitting error nor friction is caused, even if the clearance of the protruding member (such as the sleeve and the guide pin) is reduced, when the upper and the lower dies approach each other. As a result, coaxiality of the upper and the lower forming dies is improved so that the eccentricity accuracy of the molded lens can further be improved.

If the positioning member (sleeve) of each forming die is designed to be long as illustrated in FIG. 4, the eccentricity accuracy (decenter) is improved. In presence of such a protruding member, the effect of this invention is more remarkable.

### COMPARATIVE EXAMPLE

A similar bi-convex lens was press molded by an apparatus similar to that of the example except that a single heating coil with an intermediate tap and a single power supply (having a maximum output of 60 kW and a frequency of 33 kHz) utilizing a saturable reactor were used as disclosed in Japanese Patent Application Publication (JP-A) No. H05-270847. Temperature adjustment was carried out by controlling supply power by an upper-die thermocouple and controlling the reactor so that the temperatures of upper and lower forming dies are equal to each other. In this method, it takes a long time to control an upper mother die having a large volume and the cycle time was equal to 75 seconds. The lens performances of four lenses are shown in Table 2. Those lenses pressed at opposite ends of the mother dies had a large thickness and a large tilt. Thus, the lenses deviated from the tolerance range of the specification were pressed. In the examination after pressing, damage of the sleeve at the position D was observed. This is presumably because the mother dies were thermally deformed (warped) by heating.

TABLE 2

| | aspheric | | | | |
|---|---|---|---|---|---|
| | surface | molding | molding | center | |
| | eccentricity | tilt | decenter | thickness | |
| specification | | <2′ 30″ | <0.015 mm | 2 ± 0.03 | mm |
| position A | 2′ 20″ | 2′ 30″ | 0.015 mm | 2.030 | mm |
| position B | 1′ 20″ | 1′ 30″ | 0.010 mm | 2.003 | mm |
| position C | 1′ 20″ | 1′ 20″ | 0.012 mm | 1.998 | mm |
| position D | 2′ 40″ | 3′ 00″ | 0.018 mm | 2.035 | mm |

As described above, according to this invention, the upper and the lower dies can be independently controlled in temperature. Therefore, even if the heat capacities of the upper and the lower dies are considerably different, it is possible to accurately control the temperatures to desired values. Since heating by the upper-die and the lower-die heating arrangements in close proximity to each other is possible without causing a mutual interference between magnetic fluxes, the thermal loss is suppressed and production can be carried out in a short cycle time.

Although the present invention has been shown and described in conjunction with the preferred embodiment thereof, it will readily be understood by those skilled in the art that the present invention is not limited to the foregoing description but may be changed and modified in various other manners without departing from the spirit and scope of the present invention as set forth in the appended claims.

What is claimed is:

1. A press-molding apparatus comprising upper and lower dies facing with each other and upper-die and lower-die heating means for induction-heating the upper and the lower dies, respectively, wherein:
the upper-die and the lower-die heating means comprise induction heating coils as upper-die and lower-die heating coils surrounding the upper and the lower dies, respectively, and power supplies connected to the upper-die and the lower-die heating coils, respectively, the upper-die and the lower-die heating means having oscillation frequencies different from each other.

2. The press-molding apparatus according to claim 1, wherein the upper and the lower dies comprise upper and lower mother dies each of which supports a plurality of forming dies, respectively.

3. The press molding apparatus according to claim 1, further comprising a positioning member formed on at least one of confronting surfaces of the upper and the lower dies to position the upper and the lower dies relative to each other when the upper and the lower dies approach each other.

4. The press-molding apparatus according to claim 1, wherein the upper-die heating coil and the lower-die heating coil are separated by a space corresponding to 0.7 to 2 times the pitch of each heating coil.

5. A method of producing an optical element by press-molding a molding material by the use of upper and lower dies facing with each other, the method comprising the step of:
heating the upper and the lower dies to predetermined temperatures by induction-heating the upper and the lower dies with different oscillation frequencies by the use of upper-die and lower-die heating means each of which has a heating coil and a power supply.

6. A method of producing an optical element by press-molding a molding material by use of upper and lower dies facing with each other, the method comprising:
heating the upper and the lower dies in a state where the upper and lower dies are approached to be close or in contact with each other,
supplying the molding material between the upper and the lower dies when the upper and the lower dies are separated from each other, and
press-molding the molding material with the upper and the lower dies;
wherein, in said heating, the upper and the lower dies are heated to predetermined temperatures by induction-heating with the upper-die and the lower-die heating means, respectively, with oscillation frequencies different from each other, said upper-die and said lower-die heating means each of which comprises a heating coil and a power supply.

7. The method according to claim 5, wherein the oscillation frequency of one of the upper-die and the lower-die heating means is equal to 1.5 to 7 times that of the other.

8. The method according to claim 6, wherein the oscillation frequency of one of the upper-die and the lower-die heating means is equal to 1.5 to 7 times that of the other.

9. The method according to claim 7, wherein the oscillation frequency of one of the upper-die and the lower-die heating means is equal to 1.5 to 3 times that of the other.

10. The method according to claim 8, wherein the oscillation frequency of one of the upper-die and the lower-die heating means is equal to 1.5 to 3 times that of the other.
